(19) United States
(12) Patent Application Publication
(10) Pub. No.: US 2008/0195833 A1
(43) Pub. Date: Aug. 14, 2008

(54) SYSTEMS, METHODS AND COMPUTER PROGRAM PRODUCTS FOR OPERATING A DATA PROCESSING SYSTEM IN WHICH A FILE SYSTEM'S UNIT OF MEMORY ALLOCATION IS COORDINATED WITH A STORAGE SYSTEM'S READ/WRITE OPERATION UNIT

(75) Inventor: Chan-Ik Park, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/016,702

(22) Filed: Jan. 18, 2008

(30) Foreign Application Priority Data
Feb. 13, 2007 (KR) P2007-0014974

(51) Int. Cl. G06F 12/00; G06F 15/177

(52) U.S. Cl. 711/171; 709/220; 711/E12.001

(57) ABSTRACT

A data processing system is operated by obtaining a read/write operation unit size used in performing data operations in a data storage device, setting a file system unit of memory allocation size to a multiple of the read/write operation unit size, and setting a unit of memory allocation starting address to a read/write operation unit starting address used by the data storage device.

### CROSS REFERENCE TO RELATED APPLICATION

This application claims the benefit of and priority to Korean Patent Application No. P2007-0014974, filed Feb. 13, 2007, in the Korean Intellectual Property Office, the disclosure of which is hereby incorporated herein by reference as if set forth in its entirety.

### BACKGROUND OF THE INVENTION

The present invention relates generally to data processing systems and, more particularly, to the use of storage devices in data processing systems.

Data processing systems may use a file system to store and organize computer files to facilitate access to them. A file system may be viewed as a set of abstract data types that may be used for the storage, organization, manipulation, navigation, access, and retrieval of data. File systems may be categorized into three types: disk file systems, network file systems, and special purpose file systems. Disk file systems are generally designed for the storage of files on a data storage device. Network file systems generally act as a client for a remote file access protocol. Special purpose file systems generally refer to any file system that is not a disk file system or a network file system. A special purpose file system may be, for example, a system in which files are dynamically arranged by software and may be used for communication between computer processes and/or temporary file space.

As discussed above, disk file systems may be designed for storing files on a data storage device. FIG. 1 is a block diagram that illustrates a conventional data processing system 100 in which a host uses a flash memory as a data storage device to store files. Referring to FIG. 1, a conventional data processing system 100 includes a host 105, a memory controller 110, and a flash memory 115.

The memory controller 110 includes a buffer memory 120. The flash memory 115 includes a cell array 125 and a page buffer 130. Although not shown in FIG. 1, the flash memory 115 may also include a decoder, a data buffer, and/or a control unit.

The memory controller 110 may be configured to receive data and a write command from the host 105, and to control the flash memory 115 to program data into the cell array 125. The memory controller 110 may be further configured to control the flash memory 115 to read data stored in the cell array 125 responsive to a read command input from the host 105.

The buffer memory 120 temporarily stores therein data to be programmed into the flash memory 115 and data read from the flash memory 115. The buffer memory 120 transfers the temporarily stored data to the host 105 or the flash memory 115 under control of the memory controller 110.

The cell array 125 of the flash memory 115 includes a plurality of cells. The memory cells are nonvolatile and can retain stored data even when no power is applied. A page buffer 130 is a buffer that stores data to be programmed into a selected page of the cell array, or data read from a selected page.

A memory cell of the flash memory 115 is categorized into a single level cell (SLC) and a multi level cell (MLC) according to the number of data bits that can be stored therein. The SLC can store single-bit data, and the MLC can store multi-bit data.

Flash memories are often organized in terms of blocks and pages. A typical block may be 32 pages with each page being 512 bytes or 64 pages with each page being 2048 bytes. Each page typically has a few bytes associated therewith that may be used for error detection and/or correction. While a flash memory can be read or programmed in a random access fashion, it must be erased a block at a time. Flash memories may use a page size as a memory unit size for performing a read and/or write operation.

A file system that may be used to store files in the flash memory 115 of FIG. 1 may have a unit of memory allocation defined that specifies the smallest logical amount of disk space that can be allocated to hold a file. For example, the MS-DOS file system known as the File Allocation Table (FAT) calls this unit of memory allocation a cluster. Unfortunately, mismatches between the file system unit of memory allocation size and the read/write operation unit size used in a flash memory may degrade the performance of a data processing system and/or under utilize the available space of a storage device as illustrated in the following examples.

Referring to FIG. 2A, a cluster size is set to 2 KB (file system unit of memory allocation) and a page size is set to 4 KB (flash memory read/write operation unit size). Also, the cluster starting address is offset by 2 KB from the page starting address. There are two clusters of data to write into the flash memory. The program operation results in 2 KB written into a first page and 2 KB are written into a second page leaving 2 KB of unused memory in both pages. The memory is unused in the respective pages because only one program operation is allowed per page

Referring to FIG. 2B, a cluster size is set to 4 KB and a page size is set to 4 KB. Similar to FIG. 2A, the cluster starting address is offset by 2 KB from the page starting address. As a result, the single cluster is written into two pages using two separate program operations while also leaving 2 KB of unused memory in both pages. In this example, there is both underutilization of the available memory and also memory performance degradation as two program operations are used to write a single cluster of data.

Referring to FIG. 3, another example in which there is both a performance degradation and underutilization of available memory will be described. The clusters are arranged into logical pages. It is desirable to keep the logical part of the same physical page. Cluster 0 is written first into Page 0 in the flash memory. A second program operation is not permitted into Page 0, however. Therefore, to keep Cluster 0 and Cluster 1 together in the same physical page, Cluster 0 is copied into Page 1 at the same time that Cluster 1 is written into Page 1. Similar operations are performed to keep Cluster 2 and Cluster 3 together in Page 3. To keep the various logical page clusters together in the same physical page, multiple program operations are used and an entire page of memory may be wasted for each logical page (cluster pair).

### SUMMARY

Some embodiments of the present invention provide methods of operating a data processing system that includes a data storage device. The data processing system is operated by obtaining a read/write operation unit size used in performing data operations in a data storage device, setting a file system unit of memory allocation size to a multiple of the read/write operation unit size, and setting a unit of memory allocation starting address to a read/write operation unit starting address used by the data storage device.

In other embodiments, obtaining the read/write operation unit size includes sending a request from a host to the data storage device for the read/write operation unit size and receiving the read/write operation unit size at the host from the data storage device.

In still other embodiments, obtaining the read/write operation unit size further includes reading an identification of the data storage device at the data storage device responsive to receiving the request from the host, determining the read/write operation unit size based on the identification of the data storage device, and sending the determined read/write operation unit size to the host.

In still other embodiments, obtaining the read/write operation unit size further includes reading the read/write operation unit size from a register in the data storage device responsive to receiving the request from the host and sending the determined read/write operation unit size to the host.

In still other embodiments, obtaining the read/write operation unit size includes reading an identification of the data storage device and determining the read/write operation unit size based on the identification of the data storage device.

In still other embodiments, obtaining the read/write operation unit size includes reading the read/write operation unit size from a register associated with the data storage device.

In still other embodiments, the method further includes using the set unit of memory allocation size as a unit of data transmission to/from the data storage device.

In still other embodiments, the method further includes obtaining an erase operation unit size used in performing data operations in the data storage device.

In still other embodiments, the method further includes using the erase operation unit size to define an operational unit in performing a memory management operation in the data storage device under supervision of an operating system.

In still other embodiments, the memory management operation is a memory defragmentation operation.

In still other embodiments, the method further includes transmitting data using the set unit of memory allocation size as a unit of data transmission to the data storage device and performing N read/write operation unit program operations on the data storage device to write the transmitted data in the data storage device, where N is the multiple defining the relationship between the set unit of memory allocation size and the read/write operation unit size.

In still other embodiments, the data storage device comprises a solid state drive device.

In still other embodiments, the data storage device comprises a flash memory device.

In further embodiments of the present invention a data storage device is operated by receiving a request from a host for at least one parameter used in performing data operations in the data storage device, determining the at least one parameter, and sending the at least one parameter to the host.

In still further embodiments, the at least one parameter comprises a read/write operation unit size and/or an erase operation unit size.

In still further embodiments, determining the at least one parameter includes reading an identification of the data storage device and determining the at least one parameter based on the identification of the data storage device.

In still further embodiments, determining the at least one parameter includes reading the read/write operation unit size and/or erase operation unit size from a register in the data storage device.

Although described primarily above with respect to method aspects of the present invention, it will be understood that the present invention may also be embodied as systems and computer program products.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram of a conventional data processing system;

FIGS. 2A and 2B are block diagrams that illustrate the relationship between the file system unit of memory allocation size and the data storage unit read/write operation unit size;

FIG. 3 is a block diagram that illustrates the programming of logical pages in a conventional data storage system;

FIG. 4 is a block diagram that illustrates a data processing system in accordance with some embodiments of the present invention; and

FIGS. 5-7 are flowcharts that illustrate operations of the data processing system of FIG. 4 in accordance with some embodiments of the present invention.

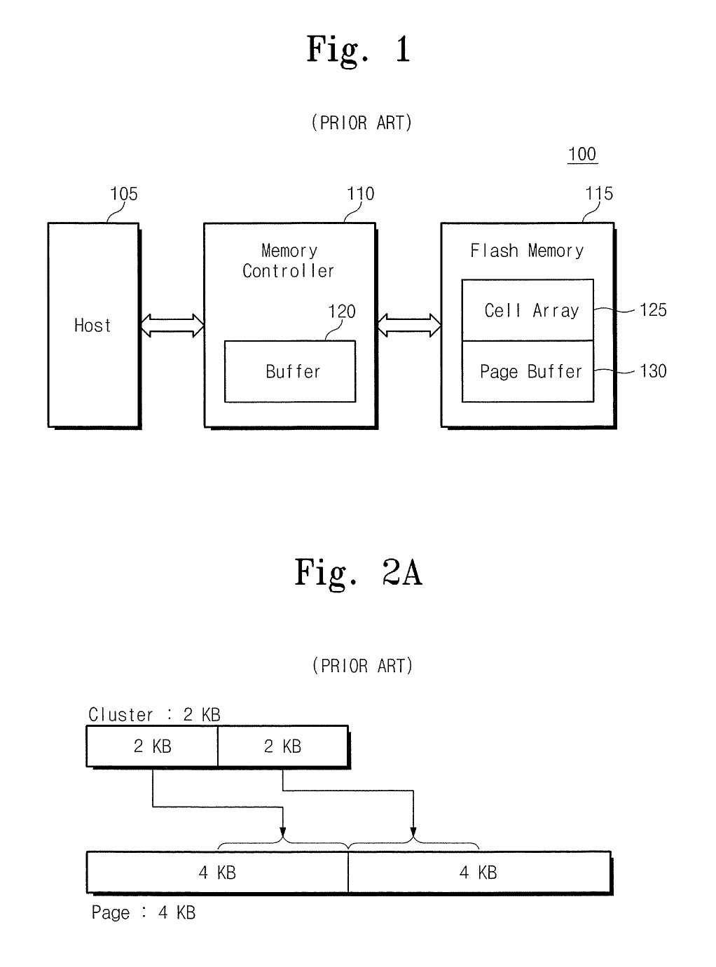

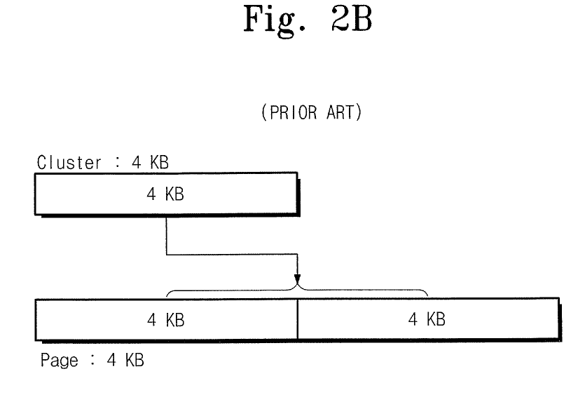

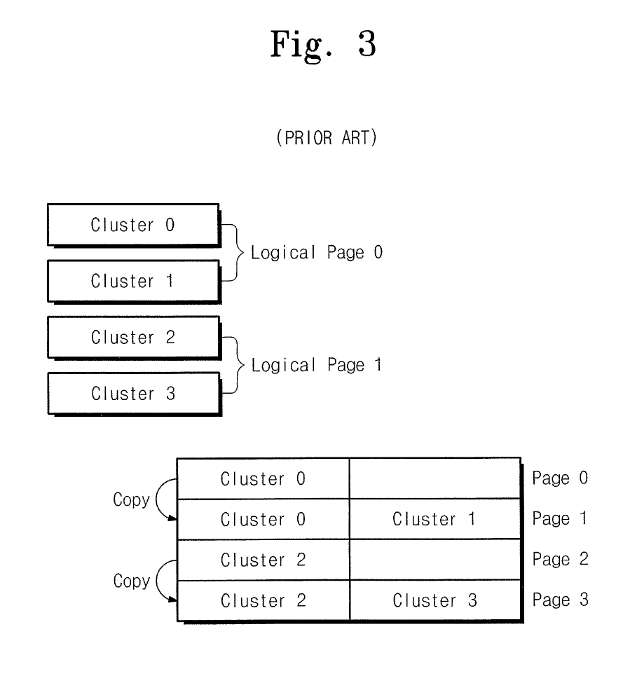

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

For purposes of illustration, various embodiments of the present invention are described herein with reference to a flash memory data storage device. It will be understood that the data storage device is not limited to implementation as a flash memory device, but can be implemented as other types of memory devices in accordance with other embodiments of the present invention.

According to some embodiments of the present invention, a data processing system that includes a data storage device can be operated by obtaining a read/write operation unit size that is used in performing data operations in the data storage device (e.g., a page size for a flash memory device). To reduce excessive read and/or program operations and to better utilize memory in the storage device, the file system unit of memory allocation size can be set to a multiple of the read/write operation unit size and the starting address of the file system's unit of memory allocation can be set to the starting address of the storage device's read/operation unit.

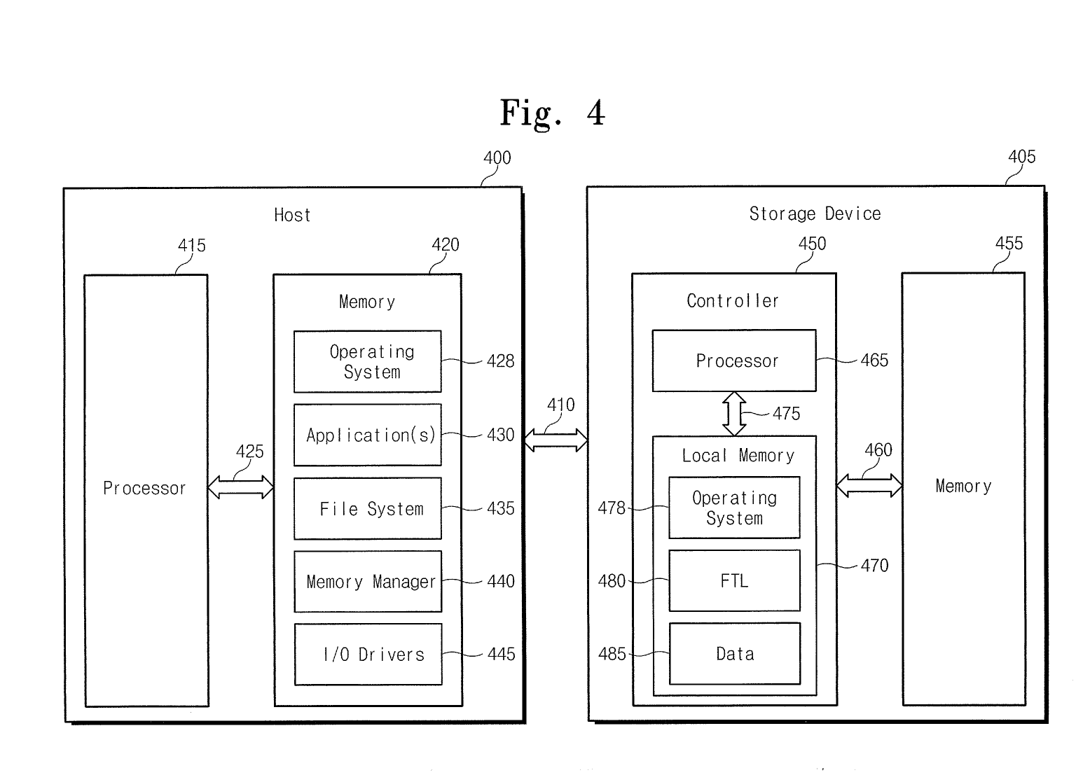

Referring now to FIG. 4, a data processing system comprises a host 400 and a storage device 405 that are coupled by an interface 410. The interface 410 may be a standardized interface, such as ATA, SATA, PATA, USB, SCSI, ESDI, IEEE 1394, IDE, and/or a card interface. The host 400 comprises a processor 415 that communicates with a memory 420 via an address/data bus 425. The processor 415 may be, for example, a commercially available or custom microprocessor. The memory 420 is representative of the one or more memory devices containing the software and data used to operate the data processing system in accordance with some embodiments of the present invention. The memory 420 may include, but is not limited to, the following types of devices: cache, ROM, PROM, EPROM, EEPROM, flash, SRAM, and DRAM.

As shown in FIG. 4, the memory 420 may contain five or more categories of software and/or data: an operating system 428, application(s) 430, a file system 435, a memory manager 440, and I/O drivers 445. The operating system 428 generally controls the operation of the host 400. In particular, the operating system 428 may manage the host's 400 software and/or hardware resources and may coordinate execution of programs by the processor 415. The application(s) 430 represent the various application programs that may run on the host 400. The file system 435 is the system used for storing and organizing computer files and/or data in the memory 420 and/or in storage locations, such as the storage device 405. The file system 435 used may be based on the particular operating system 428 running on the host 400. The memory manager 440 may manage memory access operations performed in the memory 420 and/or operations performed in an external device, such as the storage device 405. The I/O drivers 445 may be used to transfer information between the host 400 and another device (e.g., storage device 405), computer system, or a network (e.g., the Internet).

The storage device 405 comprises a controller 450 that communicates with a memory 455 via an address/data bus 460. The memory 455 may be a variety of different memory types including, but not limited to, a solid state memory, flash memory, and/or optical memory. Thus, the storage device 405 may be a Solid State Drive (SSD) device, flash memory device, hard drive, CD/DVD drive, etc. The controller 450 comprises a processor 465 that communicates with a local memory 470 via an address/data bus 475. The processor 465 may be, for example, a commercially available or custom microprocessor. The local memory 470 is representative of the one or more memory devices containing the software and data used to operate the storage device 405 in accordance with some embodiments of the present invention. The local memory 470 may include, but is not limited to, the following types of devices: cache, ROM, PROM, EPROM, EEPROM, flash, SRAM, and DRAM.

As shown in FIG. 4, the local memory 470 may contain three or more categories of software and/or data: an operating system 478, a Flash Translation Layer (FTL) module 480, and data 485. The operating system 478 generally controls the operation of the storage device 405. In particular, the operating system 478 may manage the storage device's 405 software and/or hardware resources and may coordinate execution of programs by the processor 465. The FTL module 480 may be used in flash memory devices. As discussed above, a flash chip is erased in units of blocks. The typical lifetime of a flash memory is around 100,000 erase operations per block. To avoid having one portion of a flash memory wear out sooner than another, flash devices are generally designed to distribute erase cycles throughout the memory, which may be called “wear leveling.” The FTL module 480 may be used as an interface between the file system 435 and the location of files/data in the memory 455 so that the file system 435 does not have to keep track of the actual location of files/data in the memory 455 due to wear leveling. The data module 485 may represent the buffer used for transferring files/data between the host 400 and the storage device 405.

Although FIG. 4 illustrates a data processing system software architecture in accordance with some embodiments of the present invention, it will be understood that the present invention is not limited to such a configuration but is intended to encompass any configuration capable of carrying out operations described herein.

Computer program code for carrying out operations of devices and/or systems discussed above with respect to FIG. 4 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to message flow, flowchart and/or block diagram illustrations of methods, systems, devices, and/or computer program products in accordance with some embodiments of the invention. These message flow, flowchart and/or block diagrams further illustrate exemplary operations for operating a data processing system that includes a data storage device. It will be understood that each message/block of the message flow, flowchart and/or block diagram illustrations, and combinations of messages/blocks in the message flow, flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the message flow, flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow, flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow, flowchart and/or block diagram block or blocks.

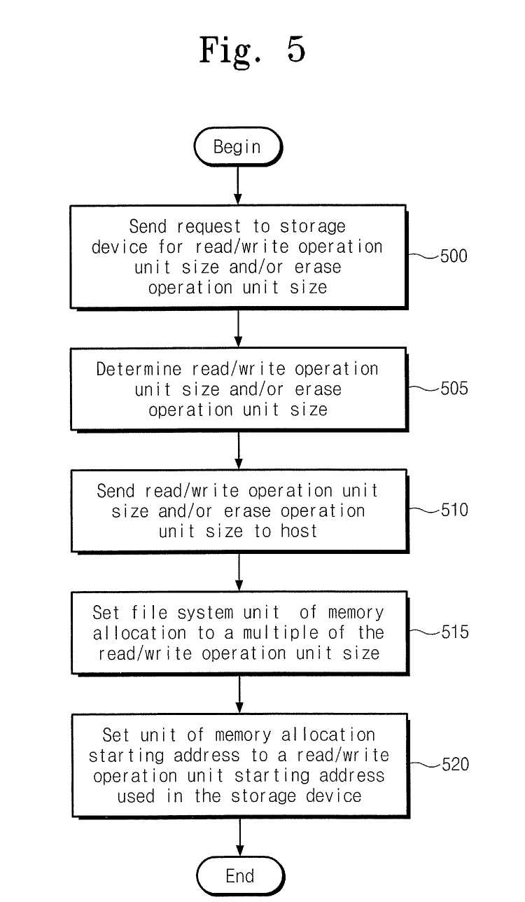

Referring to FIG. 5, operations begin at block 500 where the host 400 sends a request to the storage device 405 for the read/write operation unit size. The request may also include a request for the erase operation unit size. The storage device 405 determines the read/write operation unit size at block 505. In accordance with some embodiments of the present invention, the storage device 405 controller 450 determines the read/write operation unit size by reading an identification of the storage device and determining the read/write operation size based on the identification of the storage device. In other embodiments of the present invention, the storage device 405 controller 450 may read a read/write operation unit size from a register in the storage device 405.

At block 510, the storage device 405 sends the read/write operation unit size to the host 400. The host 400 sets the file system 435 unit of memory allocation to a multiple of the read/write operation unit size at block 515. At block 520, the host 400 sets the file system 435 unit of memory allocation starting address to a read/write operation unit starting address used in the storage device 405. By setting the file system unit of memory allocation to a multiple of the read/write operation unit size and also setting the unit of memory allocation starting address to a read/write operation unit starting address used in the storage device memory may be used more efficiently in the storage device 405 and excess programming operations may be reduced.

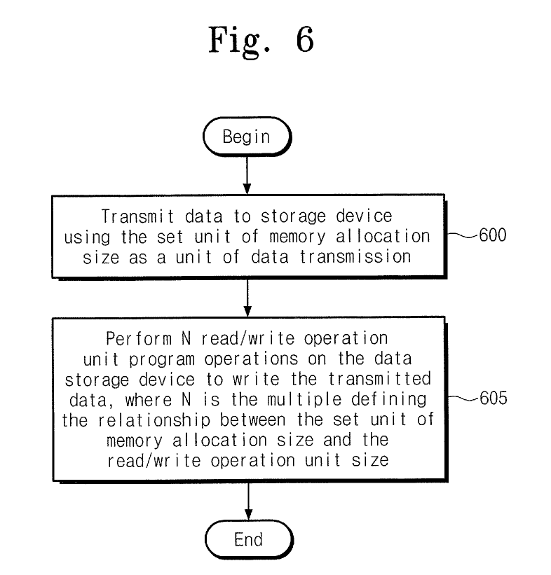

Referring to FIG. 6, a write operation from the host 400 to the storage device 405, in accordance with some embodiments of the present invention, begin at block 600 where the host 400 transmits data to the storage device 405 using the set unit of memory allocation size from block 515 of FIG. 5 as a unit of data transmission. At block 605, the storage device 405 performs N read/write operation unit program operations on the memory 455 to write the transmitted data, where N is the multiple that defines the relationship between the set unit of memory allocation size and the read/write operation unit size.

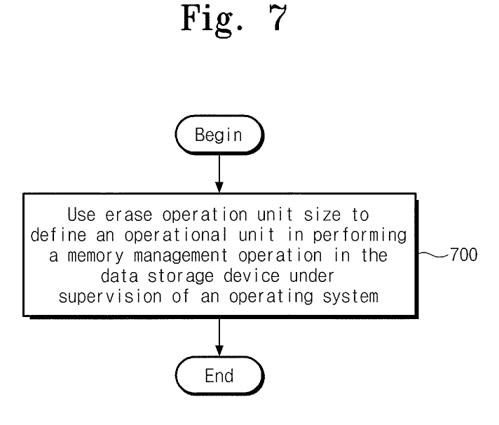

As various memory operations are performed on the storage device, it may be desirable to perform a “garbage collection” operation to form larger blocks of free, contiguous memory. Accordingly, referring to FIG. 7, the file system 435 may use the erase operation unit size obtained at block 500 of FIG. 5 to initiate a memory management operation, such as a garbage collection operation, to be performed on the storage device 405 under the supervision of the operating system 478.

The flowcharts of FIGS. 5-7 illustrate the architecture, functionality, and operations of some embodiments of methods, systems, and computer program products for operating a data processing system that includes a data storage device. In this regard, each block represents a module, segment, or portion of code, which comprises one or more executable instructions for implementing the specified logical function(s). It should also be noted that in other implementations, the function(s) noted in the blocks may occur out of the order noted in FIG. 5-7. For example, two blocks shown in succession may, in fact, be executed substantially concurrently or the blocks may sometimes be executed in the reverse order, depending on the functionality involved.

Many variations and modifications can be made to the embodiments without substantially departing from the principles of the present invention. All such variations and modifications are intended to be included herein within the scope of the present invention, as set forth in the following claims.

That which is claimed:

1. A method of operating a data processing system, comprising:
obtaining a read/write operation unit size used in performing data operations in a data storage device;
setting a file system unit of memory allocation size to a multiple of the read/write operation unit size; and
setting a unit of memory allocation starting address to a read/write operation unit starting address used by the data storage device.

2. The method of claim 1, wherein obtaining the read/write operation unit size comprises:
sending a request from a host to the data storage device for the read/write operation unit size; and
receiving the read/write operation unit size at the host from the data storage device.

3. The method of claim 2, wherein obtaining the read/write operation unit size further comprises:
reading an identification of the data storage device at the data storage device responsive to receiving the request from the host;
determining the read/write operation unit size based on the identification of the data storage device; and
sending the determined read/write operation unit size to the host.

4. The method of claim 2, wherein obtaining the read/write operation unit size further comprises:
reading the read/write operation unit size from a register in the data storage device responsive to receiving the request from the host; and
sending the determined read/write operation unit size to the host.

5. The method of claim 1, wherein obtaining the read/write operation unit size comprises:
reading an identification of the data storage device; and
determining the read/write operation unit size based on the identification of the data storage device.

6. The method of claim 1, wherein obtaining the read/write operation unit size comprises:
reading the read/write operation unit size from a register associated with the data storage device.

7. The method of claim 1, further comprising:
using the set unit of memory allocation size as a unit of data transmission to/from the data storage device.

8. The method of claim 1, further comprising:
obtaining an erase operation unit size used in performing data operations in the data storage device.

9. The method of claim 8, further comprising:
using the erase operation unit size to define an operational unit in performing a memory management operation in the data storage device under supervision of an operating system.

10. The method of claim 9, wherein the memory management operation is a memory defragmentation operation.

11. The method of claim 1, further comprising:
transmitting data using the set unit of memory allocation size as a unit of data transmission to the data storage device; and
performing N read/write operation unit program operations on the data storage device to write the transmitted data in the data storage device, where N is the multiple defining the relationship between the set unit of memory allocation size and the read/write operation unit size.

12. The method of claim 1, wherein the data storage device comprises a solid state drive device and/or a flash memory device.

13. A method of operating a data storage device, comprising:
receiving a request from a host for at least one parameter used in performing data operations in the data storage device;
determining the at least one parameter; and
sending the at least one parameter to the host.

14. The method of claim 13, wherein the at least one parameter comprises a read/write operation unit size and/or an erase operation unit size.

15. The method of claim 13, wherein determining the at least one parameter comprises:
reading an identification of the data storage device; and
determining the at least one parameter based on the identification of the data storage device.

16. The method of claim 13, wherein determining the at least one parameter comprises:
reading the read/write operation unit size and/or erase operation unit size from a register in the data storage device.

17. A data processing system, comprising:
a processor; and
a computer readable medium coupled to the processor, the computer readable medium including computer readable program code thereon, the computer readable program code comprising:
computer readable program code configured to obtain a read/write operation unit size used in performing data operations in a data storage device;
computer readable program code configured to set a file system unit of memory allocation size to a multiple of the read/write operation unit size; and
computer readable program code configured to set a unit of memory allocation starting address to a read/write operation unit starting address used by the data storage device.

18. A data storage device, comprising:
a processor; and
a computer readable medium coupled to the processor, the computer readable medium including computer readable program code thereon, the computer readable program code comprising:
computer readable program code configured to receive a request from a host for at least one parameter used in performing data operations in the data storage device;
computer readable program code configured to determine the at least one parameter; and
computer readable program code configured to send the at least one parameter to the host.

19. A data processing system, comprising:
a data storage device; and
a host coupled to the data storage device, the host comprising a processor that is configured to obtain a read/write operation unit size used in performing data operations in a data storage device, set a file system unit of memory allocation size to a multiple of the read/write operation unit size, and set a unit of memory allocation starting address to a read/write operation unit starting address used by the data storage device.

20. The data processing system of claim 19, wherein the host processor is further configured to send a request to the data storage device for the read/write operation unit size, and to receive the read/write operation unit size from the data storage device.

21. The data processing system of claim 20, wherein the data storage device comprises a processor, the data storage device processor being configured to read an identification of the data storage device responsive to receiving the request from the host, to determine the read/write operation unit size based on the identification of the data storage device, and to send the determined read/write operation unit size to the host.

22. The data processing system of claim 20, wherein the data storage device comprises a processor, the data storage device processor being configured to read the read/write operation unit size from a register in the data storage device responsive to receiving the request from the host, and to send the determined read/write operation unit size to the host.

23. The data processing system of claim 19, wherein the host processor is further configured to read an identification of the data storage device, and to determine the read/write operation unit size based on the identification of the data storage device.

24. The data processing system of claim 19, wherein the host processor is further configured to read the read/write operation unit size from a register associated with the data storage device.

25. The data processing system of claim 19, wherein the host processor is further configured to transmit data using the set unit of memory allocation size as a unit of data transmission to the data storage device; and
wherein the data storage device comprises a processor, the data storage device processor being configured to perform N read/write operation unit program operations to write the transmitted data in the data storage device, where N is the multiple defining the relationship between the set unit of memory allocation size and the read/write operation unit size.
